(19) United States
(12) Patent Application Publication
(10) Pub. No.: US 2004/0195192 A1
(43) Pub. Date: Oct. 7, 2004

(54) Display assembly

(76) Inventors: Paul Belokin, Denton, TX (US); Martin P. Belokin, Denton, TX (US); Norman P. Belokin, Corinth, TX (US)

Correspondence Address: HUNTON & WILLIAMS LLP, 1601 BRYAN STREET, ENERGY PLAZA - 30TH FLOOR, DALLAS, TX, 75201, US

(21) Appl. No.: 10/407,990

(22) Filed: Apr. 7, 2003

(51) Int. Cl. B42F 1/00

(52) U.S. Cl. 211/59.1; 211/57.1

(57) ABSTRACT

Display hook assemblies provided with a removeable display panel are mounted on the forward edge of a merchandise display shelf. The display assembly has a base portion which attaches to the shelf and supports a product hook which depends from the forward edge of the shelf A removeable display panel is detachably secured to the base. The display panel may be removed and replaced without disturbing products suspended from the hook or other products displayed on the shelf.

This invention relates to assemblies for display of hangable products and hangable product containers such as tabbed boxes, wrappers, packets and the like. More particularly, it relates to merchandise display assemblies adapted for mounting on conventional shelving to support and display hangable products and display media such as advertising graphics and the like associated with the products.

Retail businesses commonly display products for sale on vertically stacked horizontal shelves or the like. Because a passing customer is more likely to select and purchase merchandise displayed where it can be readily seen and recognized, retailers often maximize visibility of products on display by suspending or otherwise hanging the products on the forward edge of a display shelf. Products displayed on shelf edges are much more visible and accessible, thus are more likely to be the subject of impulse purchases.

Various devices are used to support and display products on shelf edges. Most such devices are simply hooks attached to the shelves and thus display no advertising graphics. Instead, the retailer relies on visibility of the product itself to advertise the product.

Many retailers rely on information displayed in graphics (such as bar code labels, etc.) for inventory control and pricing information. Accordingly, a bar code label or similar label is often used in connection with the product display. Such label displays, however, are difficult to conveniently use in connection with products suspended from a simple hook. Furthermore, it is often desireable to employ various other attention-attracting devices (such as advertising graphics, sales displays, motion-active or light-active -devices and the like) in connection with hanging product. However, such devices are not readily adapted to be mounted on shelf edges to be used in connection with hanging product.

In accordance with the present invention, product display hooks are adapted to be mounted adjacent the forward edge of conventional retail display shelves to suspend and display product at the forward edge of the shelf. The display hooks are removeable so that the display shelves may be used in their conventional manner without the hooks if desired. The display hook assembly comprises a base adapted to be attached to the forward edge of the shelf by a pin which extends from the base and mates with an aperture in the shelf. A hook depends from the base on which products may be suspended and displayed. A display flange is supported on the base directly above the hook, preferably intermediate the hook and the base. The display flange lies in a plane substantially normal to the plane of the display shelf on which the hook is mounted and provides a substantially flat face on which graphic information (such as a bar code label, price label, etc.) may be displayed. The display flange is also adapted to mate with and support a removeable display panel on which graphics or other display material may be supported. Accordingly, displays on the display panel may be readily changed or removed by simply removing or replacing the display panel without removing, replacing or otherwise disturbing product suspended on the hook. Accordingly, the advertising or other display associated with product suspended on the display hook of the invention can be quickly and easily removed, changed or revised without disturbing displayed product. Other features and advantages of the invention will become more readily understood from the following detailed description taken in connection with the appended claims and attached drawing in which:

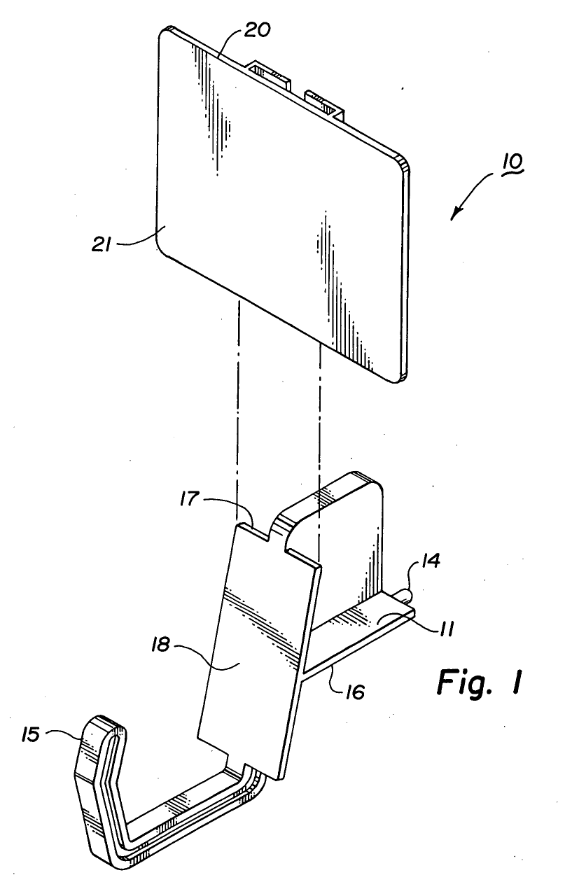

FIG. 1 is an exploded perspective view of a preferred embodiment of the display hook assembly of the invention;

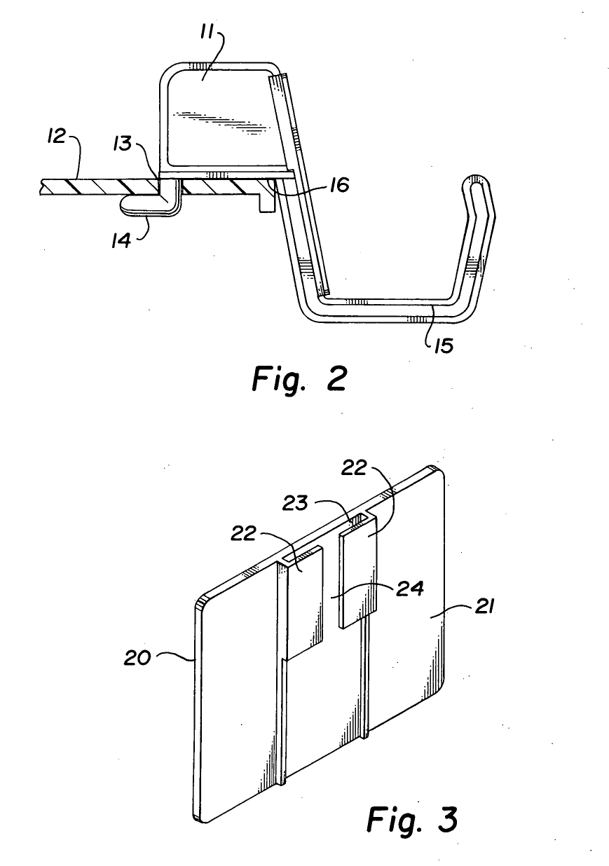

FIG. 2 is a side elevational view of the base portion of the assembly of FIG. 1 illustrating mounting of the display hook assembly on a merchandise display shelf, and

FIG. 3 is a rear perspective view of the removeable display panel shown in FIG. 1.

The above-described drawing is incorporated into and forms part of the specification to illustrate exemplary embodiments of the present invention. Throughout the drawing, like reference numerals designate corresponding elements. The figures are not to scale but are intended to disclose inventive concepts by illustration. Therefore, the drawing is not to be construed as limiting the invention to the illustrated examples.

It will be also recognized that the principles of the invention may be utilized and embodied in many and various forms. In order to demonstrate these principles, the invention is described herein by reference to specific preferred embodiments. The invention, however, is not limited to the specific forms illustrated and described. Furthermore, the invention is not limited to use in connection with horizontally disposed retail merchandise display shelves but may find utility in other similar applications involving display of information in connection with hangable products.

For purposes of this disclosure, the term “hook” is used to mean any structure on which a product, a package containing a product, or advertising media for a product may be suspended for display. Similarly, the term “shelf” is used to mean any structure having a surface on which a product, a package containing a product, or advertising media may be placed for display.

For perspective and consistency in describing the embodiment of the invention illustrated, the portion of the shelf on which the display assembly is supported is described herein as the front or forward edge. The upper horizontal face of the shelf as illustrated is described as the top face of the shelf regardless of the orientation of the shelf on which the display hook assembly is mounted.

In the embodiment illustrated in FIGS. 1, 2 and 3 the display hook assembly 10 comprises a support base 11 which supports a removeable display panel 20. The support base 11 has a bottom face 16 lying in a substantially horizontal plane and is adapted to be secured to the forward edge of a display shelf 12.

Retail merchandise display shelves are conveniently provided with a plurality of apertures such as holes 13, slots or the like spaced from the forward edge of the shelf 12. To secure the support base 11 to the shelf 12, support base 11 is provided with an L-shaped pin 14, tongue or the like. One portion of pin 14 depends from the bottom face 16 of the base 11 and the other portion projects in a plane substantially parallel with and spaced form the bottom face 16 of the base 11 as shown in FIG. 2. A hook 15, finger or the like depends from the base 11 at a position to depend from the forward edge of the shelf 12 and project outwardly from the forward edge of the shelf 12. It will be recognized, therefore, that support base 11 may be attached to the display shelf 12 by simply inserting pin 14 into hole 13 and rotating the support base 11 until its bottom face 16 lies adjacent the top surface of the display shelf 12 and hook 15 projects outwardly from the forward edge of display shelf 12. The hook 15 illustrated is a large U-shaped finger on which various products or package may be suspended. Obviously, shapes other than that illustrated may be employed, depending on the shape, dimensions, etc., of the product units to be displayed thereon.

In many retail establishments, pricing information, inventory information and the like is encoded in bar code strips or the like displayed on the product and/or on the shelf on which the product is displayed. In order to conveniently display such information and to permit electronic scanning of such bar code strips, the strips must be placed in close proximity with the product and in a position which permits unobstructed viewing. For this purpose, base support 11 also includes a display flange 17 which includes a flat surface on the outer flange face 18. The flat surface of flange face 18 is preferably disposed directly above hook 15 and may, as illustrated, be positioned intermediate hook 15 and support base 11. For maximum visibility flange face 18 lies in a substantially vertical plane substantially normal to the plane of the bottom face 16. In the preferred embodiment, the face 18 of display flange 17 is sized and shaped to accommodate a conventional bar code label or the like. Accordingly, bar code information, pricing, etc, may be displayed on the face 18 of display flange 17 directly above the product suspended on hook 15.

In many situations it is desireable to display other information (such as advertising, active signs, lighting etc.) in conjunction with the product suspended in hook 15. Furthermore, it is often desireable that the other information to be displayed be readily changeable without removing or otherwise disturbing product suspended on hook 15. For this purpose the display hook assembly of the invention includes a removeable display panel 20 which is readily attachable to and removeable from the support base 11.

In the preferred embodiment display panel 20 comprises a substantially rectangular (although any other shape may be used) panel having oppositely disposed front and back major faces 21, 22. Advertising or other graphic or active display may be formed in or attached to the front major face 21 or back major face 22. Back major face 22 carries a receiver adapted to receive display flange 17 and thereby mount display panel 20 on base 11. In the embodiment illustrated, the receiver comprises opposed bosses or flanges 22 separated by a vertically extending slot 24 and defining a channel 23 which approximates the dimensions of display flange 17. Accordingly, removeable display panel 20 may be readily mounted on base support 11 by inserting display flange 17 in channel 23. When so inserted, front major face 21 of removeable display panel 20 is positioned above hook 15 and the removeable display panel 20 may be used as a support for display information. However, since display panel 20 is attached to base support 11 by sliding channel 23 over display flange 17 from above, display panel 20 may be easily added to or removed from support base 11 as desired without removing or in any other way disturbing product suspended on hook 15. Thus advertising displays and the like supported on display panel 20 may be changed, removed or substituted as desired without otherwise affecting support and display of product suspended on a shelf with base support 11.

In the embodiment illustrated, flanges 23 are positioned to define a channel 24 which is centrally located near the top edge of back major face 22, thus positioning front major face 21 directly above hook 15 when display panel 20 is mounted on support base 11. It will be readily recognized, however, that the channel 24 may be positioned at any desired location or origination to position front major face 21 in the orientation or location desired. Similarly, the display panel receiver and display flange 17 need not necessarily be formed in the rectangular shape and dimensions illustrated. Any arrangement of similar components, such as slotted grooves with mating tongues, mating notches and pins, etc., which removeably secure the display panel 20 to the base support 11 will serve as equivalent structure for accomplishing the same function.

The display hook assembly of the invention may be readily be fabricated from any of various suitable materials. In the preferred embodiment, the structures are formed of molded plastics, acrylics or the like to form unitary transparent, translucent or tinted bodies. Obviously, various other materials and manufacturing technologies may be used as desired.

From the foregoing it will be recognized that the principles of the invention may be employed in various arrangements to obtain the benefit of the many advantages and features disclosed. It is to be understood, therefore, that even though numerous characteristics and advantages of the invention have been set forth together with details of the structure and function of the invention, this disclosure is to be considered illustrative only. Various changes and modifications may be made in detail, especially in matters of size, shape and arrangements and combination of parts, without departing from the spirit and scope of the invention as defined by the appended claims.

What is claimed:

1. A display hook assembly comprising:
(a) a base having a bottom face extending in a first plane;
(b) a pin extending from said base adapted to secure said base to a display shelf;
(c) a hook depending from said base; and
(d) a display panel removeably secured to said base.

2. A display hook assembly as defined in claim 1 wherein said pin is a substantially L-shaped member having a first portion extending from said bottom face and a second portion extending substantially parallel with and spaced from said bottom face.

3. A display hook assembly as defined in claim 1 including a display flange having a flange face extending in a plane substantially normal to said first plane.

4. A display hook assembly as defined in claim 3 wherein said display panel comprises a panel having oppositely disposed front and back major faces with a receiver on said back major face adapted to receive said display flange and removeably mount said display panel on said base.

5. A display hook assembly as defined in claim 4 wherein said receiver is defined by opposed flanges which define a channel adapted to receive said display flange.
